(19) United States
(12) Patent Application Publication
(10) Pub. No.: US 2014/0034885 A1
(43) Pub. Date: Feb. 6, 2014

(54) STABILIZATION OF ONE-POT METHAMPHETAMINE SYNTHESIS SYSTEMS

(71) Applicant: Acura Pharmaceuticals, Inc., Palantine, IL (US)

(72) Inventor: Ronald L. Leech, Plymouth, IN (US)

(73) Assignee: Acura Pharmaceuticals, Inc., Palantine, IL (US)

(21) Appl. No.: 13/955,778

(22) Filed: Jul. 31, 2013

Related U.S. Application Data
(60) Provisional application No. 61/678,381, filed on Aug. 1, 2012.

(51) Int. Cl. B01J 20/26

(52) U.S. Cl. CPC B01J 20/26
USPC 252/602; 252/194; 210/679

(57) ABSTRACT

Methods and compositions for stabilizing methamphetamine laboratories, such as by mitigating their explosive potential.

### CROSS REFERENCE TO RELATED APPLICATIONS

This application claims the benefit of U.S. Provisional Patent Application No. 61/678,381 filed on Aug. 1, 2012, which is incorporated herein by reference in its entirety.

### BACKGROUND OF THE INVENTION

Methamphetamines may be synthesized in a single container, known as a “one-pot” system. The ingredients used in such one-pot reaction may combine to create an extremely unstable environment where explosion is of high potential, thus making it dangerous for law enforcement to handle and/or transport such systems upon their discovery.

### BRIEF SUMMARY OF THE INVENTION

According to some embodiments of the present invention, an active methamphetamine synthesis laboratory quenching powder mixture includes a hygroscopic polymer; a disintegrant; an ion exchange resin; and a water soluble dye.

In some embodiments, the hygroscopic polymer is present in an amount of about 17 wt % to about 23 wt % of the powder mixture, and may comprise polyethylene oxide. In some embodiments, the disintegrant is present in an amount of about 35 wt % to about 45 wt % of the powder mixture, and may comprise crospovidone. In some embodiments, the ion exchange resin is present in an amount of about 35 wt % to about 45 wt % of the powder mixture, and may comprise sodium polyacrylate. In some embodiments, the water soluble dye is present in an amount of about 0.7 wt % to about 2 wt % of the powder mixture.

According to some embodiments of the present invention, an inactive methamphetamine synthesis laboratory quenching powder mixture includes gypsum; a hygroscopic polymer; and a hydrocarbon absorbent polymer. In some embodiments, the gypsum is present in an amount of about 65 wt % to about 80 wt % of the powder mixture; the hygroscopic polymer is present in an amount of about 2 wt % to about 6 wt % and may comprise polyethylene oxide; and/or the hydrocarbon absorbent polymer is present in an amount of about 15 wt % to about 20 wt % and may comprise polypropylene hydrocarbon absorbent powder.

According to some embodiments of the present invention, an inactive methamphetamine synthesis laboratory quenching powder mixture includes gypsum; an ion exchange resin; and a hydrocarbon absorbent polymer. In some embodiments, the gypsum is present in an amount of about 65 wt % to about 80 wt % of the powder mixture; the ion exchange resin is present in an amount of about 15 wt % to about 20 wt % and may comprise Amberlite; and/or the hydrocarbon absorbent polymer is present in an amount of about 15 wt % to about 20 wt % and may comprise polypropylene hydrocarbon absorbent powder.

According to some embodiments of the present invention, a method of stabilizing an active methamphetamine synthesis vessel comprises adding the powder mixture of to a vessel containing solvent and lithium. In some embodiments, the method includes sequestering the solvent from the lithium, such as in a matrix.

According to some embodiments, a method of stabilizing an inactive methamphetamine synthesis vessel comprises adding the powder mixture to a vessel containing lithium.

### BRIEF DESCRIPTION OF THE SEVERAL VIEWS OF THE DRAWINGS

FIG. 1 shows an active methamphetamine synthesis laboratory.

FIG. 2 shows an inactive methamphetamine synthesis laboratory.

FIG. 3 shows a sequestered active methamphetamine synthesis laboratory.

FIG. 4 shows an agglomerated active methamphetamine synthesis laboratory.

FIG. 5 shows a sequestered and quenched inactive methamphetamine synthesis laboratory.

### DETAILED DESCRIPTION OF THE INVENTION

The present invention relates to methods and compositions for stabilizing methamphetamine laboratories, such as by mitigating their explosive potential. A system for synthesizing methamphetamines in a single vessel, such as a bottle or can, may be known as a “one-pot system,” and may often contain a non-polar solvent (including but not limited to fuels, starter fluid, heptanes, etc.), sodium hydroxide, ammonium nitrate, lithium, water, and cold medicine containing ephedrine. When provided in certain combinations, these ingredients may create an unstable, and potentially explosive environment.

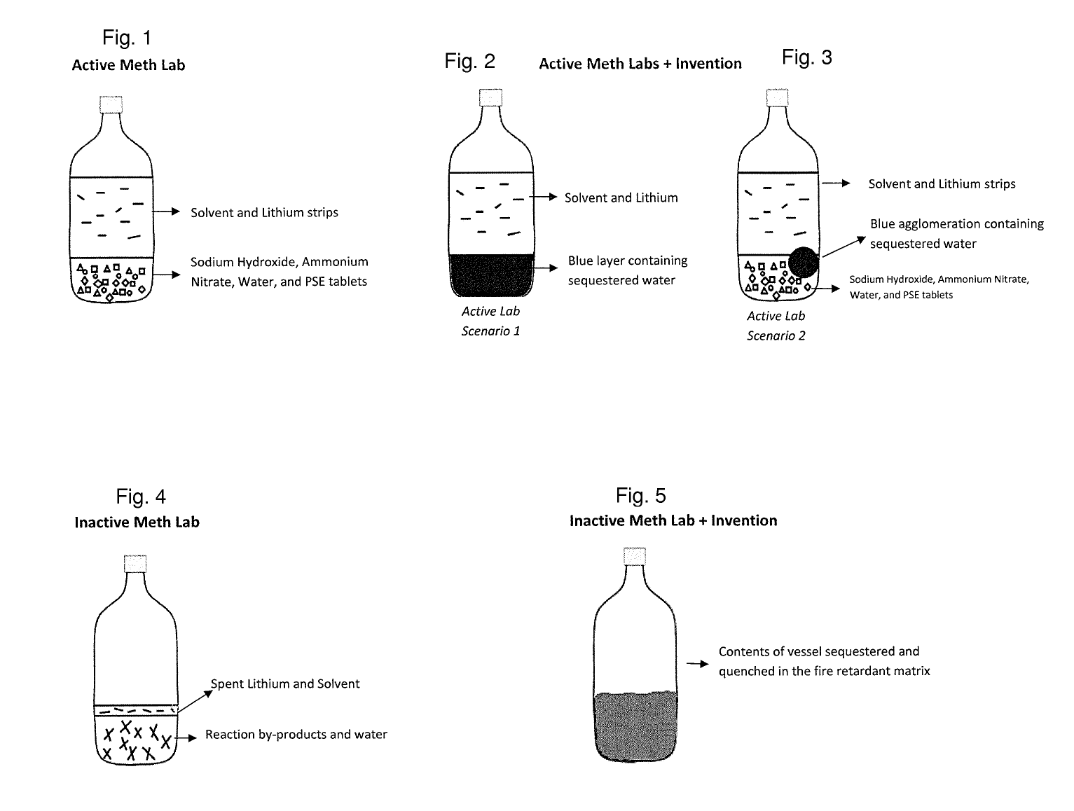

When located by law enforcement, methamphetamine laboratories may either be in an active condition or an inactive condition. For example, an active methamphetamine laboratory is a one-pot reaction containing solvent and lithium, as illustrated in FIG. 1. An active methamphetamine laboratory may be particularly dangerous to handle and/or transport because the lithium or other constituents in the vessel can initiate or continue a thermal reaction which can spontaneously ignite. For example, the flash caused by the lithium can then ignite the fuel in the vessel, causing an explosion. In this way, an active methamphetamine laboratory may be analogous to a bomb which requires defusing.

An inactive methamphetamine laboratory is a one-pot reaction in which most of the solvent has been removed and the lithium has been depleted, as illustrated in FIG. 2. An inactive laboratory may also be dangerous, however, because any remaining lithium has the potential to flash and burn.

In some embodiments of the present invention, a field kit may mitigate the explosive potential of active and/or inactive methamphetamine laboratories and may significantly improve safety in handling and transport of the clandestine laboratories.

Active Methamphetamine Laboratory Quench Kit

In some embodiments, an active methamphetamine laboratory quench kit may be used to mitigate the explosive potential of an active one-pot methamphetamine synthesis vessel. In an active methamphetamine laboratory, the act of lithium coming in contact with the small amount of water in the vessel may cause a flash, thereby igniting the fuel. An active methamphetamine laboratory quench kit may function to effectively sequester the water in the vessel and thereby prevent it from contacting the lithium or other constituents in the one-pot system. Once the water is sequestered, the lithium will be stable in the solvent and the reaction vessel can be handled and moved more safely.

In some embodiments, an active methamphetamine laboratory quench kit includes a quenching packet or canister of a powder mixture. The powder mixture may include, but is not limited to, hygroscopic polymer, disintegrant, ion-exchange resin, water-soluble dye, or combinations thereof.

In some embodiments, the powder mixture in an active laboratory quench kit includes a suitable hygroscopic polymer, such as, but not limited to polyethylene oxide (“PEO”), nylon, ABS, polycarbonate, cellulose, and poly(methyl methacrylate). In some embodiments, the powder mixture includes hygroscopic powder in an amount of about 5 wt % to about 35 wt % of the powder mixture; about 10 wt % to about 30 wt % of the powder mixture; about 15 wt % to about 25 wt % of the powder mixture; about 17 wt % to about 23 wt % of the powder mixture; about 5 wt % of the powder mixture; about 7.5 wt % of the powder mixture; about 10 wt % of the powder mixture; about 12.5 wt % of the powder mixture; about 15 wt % of the powder mixture; about 17.5 wt % of the powder mixture; about 19.8 wt % of the powder mixture; about 20 wt % of the powder mixture; about 22.5 wt % of the powder mixture; about 25 wt % of the powder mixture; about 27.5 wt % of the powder mixture; about 30 wt % of the powder mixture; about 32.5 wt % of the powder mixture; or about 35 wt % of the powder mixture.

In some embodiments, the powder mixture in an active laboratory quench kit includes a suitable disintegrant such as a super disintegrant, including but not limited to crospovidone, sodium starch glycolate and croscarmellose sodium. In some embodiments, the powder mixture includes disintegrant in an amount of about 25 wt % to about 55 wt % of the powder mixture; about 30 wt % to about 50 wt % of the powder mixture; about 35 wt % to about 45 wt % of the powder mixture; about 25 wt % of the powder mixture; about 27.5 wt % of the powder mixture; about 30 wt % of the powder mixture; about 32.5 wt % of the powder mixture; about 35 wt % of the powder mixture; about 37.5 wt % of the powder mixture; about 39.6 wt % of the powder mixture; about 40 wt % of the powder mixture; about 42.5 wt % of the powder mixture; about 45 wt % of the powder mixture; about 47.5 wt % of the powder mixture; about 50 wt % of the powder mixture; about 52.5 wt % of the powder mixture; or about 55 wt % of the powder mixture.

In some embodiments, the powder mixture in an active laboratory quench kit includes an ion exchange resin such as, but not limited to, Amberlite™ ion exchange resin, sodium polyacrylate, sodium polystyrene sulfonate, colestipol, and cholestyramine. In some embodiments, the powder mixture includes ion exchange resin in an amount of about 25 wt % to about 55 wt % of the powder mixture; about 30 wt % to about 50 wt % of the powder mixture; about 35 wt % to about 45 wt % of the powder mixture; about 25 wt % of the powder mixture; about 27.5 wt % of the powder mixture; about 30 wt % of the powder mixture; about 32.5 wt % of the powder mixture; about 35 wt % of the powder mixture; about 37.5 wt % of the powder mixture; about 39.6 wt % of the powder mixture; about 40 wt % of the powder mixture; about 42.5 wt % of the powder mixture; about 45 wt % of the powder mixture; about 47.5 wt % of the powder mixture; about 50 wt % of the powder mixture; about 52.5 wt % of the powder mixture; or about 55 wt % of the powder mixture.

In some embodiments, the powder mixture in an active laboratory quench kit includes any suitable water soluble dye such as, but not limited to, Blue #9 powder or Red #1 powder. In some embodiments, the powder mixture contains a water soluble dye in an amount of about 0.1 wt % to about 5 wt % of the powder mixture; about 0.3 wt % to about 4 wt % of the powder mixture; about 0.5 wt % to about 3 wt % of the powder mixture; about 0.7 wt % to about 2 wt % of the powder mixture; about 0.1 wt % of the powder mixture; about 0.2 wt % of the powder mixture; about 0.3 wt % of the powder mixture; about 0.4 wt % of the powder mixture; about 0.5 wt % of the powder mixture; about 0.6 wt % of the powder mixture; about 0.7 wt % of the powder mixture; about 0.8 wt % of the powder mixture; about 0.9 wt % of the powder mixture; about 0.99 wt % of the powder mixture; about 1 wt % of the powder mixture; about 2 wt % of the powder mixture; about 3 wt % of the powder mixture; about 4 wt % of the powder mixture; about 5 wt % of the powder mixture; about 6 wt % of the powder mixture; about 7 wt % of the powder mixture; about 8 wt % of the powder mixture; about 9 wt % of the powder mixture; or about 10 wt % of the powder mixture.

The powder composition may be introduced to the active one-pot vessel using a funnel or any other suitable transfer device. In some embodiments, the powder composition acts as a sequestering and/or quenching agent, and a visually distinct layer, as shown in FIG. 3, or agglomeration, as shown in FIG. 4, may form after introduction of the powder mixture to the vessel. Such a layer or agglomeration may form within a few minutes, and may indicate that the water has been successfully sponged and sequestered within the matrix of the sequestering/quenching agent. At this point, the lab may be handled and transported in a safer manner. Advantageously, in some embodiments, the solvent layer containing the methamphetamine will not compromised by this invention, allowing it to be further processed as evidence.

Inactive Methamphetamine Laboratory Quench Kit

In some embodiments, an active methamphetamine laboratory quench kit may be used to mitigate the risk of fire inside a one-pot methamphetamine synthesis vessel. An inactive methamphetamine laboratory may be depleted of solvent and active lithium. However, the lack of solvent in the container may put any remaining lithium in close contact with water inside the vessel. Handling and transporting the vessel can further enhance the likelihood that the lithium contacts the water and catches fire. While most of the solvent or fuel is no longer inside the vessel, a fire in the trunk of a vehicle or hands of an unsuspecting person in the field is clearly dangerous.

An inactive methamphetamine laboratory quench kit may effectively smoother and sequester the remaining reactant materials in the inactive methamphetamine synthesis vessel. In some embodiments, an inactive methamphetamine laboratory quench kit may include a quenching packet or canister of a powder mixture. The powder mixture may include, but is not limited to, gypsum, hygroscopic polymer, ion-exchange resin, a hydrocarbon absorbent polymer, or combinations thereof.

In some embodiments, a powder mixture in an inactive laboratory quench kit includes gypsum in an amount of about 50 wt % to about 95 wt % of the powder mixture; about 55 wt % to about 90 wt % of the powder mixture; about 60 wt % to about 85 wt % of the powder mixture; about 65 wt % to about 80 wt % of the powder mixture; about 50 wt % of the powder mixture; about 52.5 wt % of the powder mixture; about 55 wt % of the powder mixture; about 57.5 wt % of the powder mixture; about 60 wt % of the powder mixture; about 62.5 wt % of the powder mixture; about 65 wt % of the powder mixture; about 66.7 wt % of the powder mixture; about 67.5 wt % of the powder mixture; about 70 wt % of the powder mixture; about 72.5 wt % of the powder mixture; about 75 wt % of the powder mixture; about 76.9 wt % of the powder mixture; about 77.5 wt % of the powder mixture; about 80 wt % of the powder mixture; about 82.5 wt % of the powder mixture; about 85 wt % of the powder mixture; about 87.5 wt % of the powder mixture; or about 90 wt % of the powder mixture.

In some embodiments, the powder mixture in an inactive laboratory quench kit includes a suitable hygroscopic polymer, such as, but not limited to polyethylene oxide (“PEO”), nylon, ABS, polycarbonate, cellulose, and poly(methyl methacrylate). In some embodiments, a powder mixture includes hygroscopic polymer in an amount of about 1 wt % to about 10 wt % of the powder mixture; about 1 wt % to about 8 wt % of the powder mixture; about 2 wt % to about 6 wt % of the powder mixture; about 1 wt % of the powder mixture; about 2 wt % of the powder mixture; about 3 wt % of the powder mixture; about 3.8 wt % of the powder mixture; about 4 wt % of the powder mixture; about 5 wt % of the powder mixture; about 6 wt % of the powder mixture; about 7 wt % of the powder mixture; about 8 wt % of the powder mixture; about 9 wt % of the powder mixture; or about 10 wt % of the powder mixture.

In some embodiments, the powder mixture in an inactive laboratory quench kit includes an ion exchange resin such as, but not limited to, Amberlite™ ion exchange resin, sodium polyacrylate, sodium polystyrene sulfonate, colestipol, and cholestyramine. In some embodiments, a powder mixture includes ion exchange resin in an amount of about 5 wt % to about 25 wt % of the powder mixture; about 10 wt % to about 20 wt % of the powder mixture; about 15 wt % to about 20 wt % of the powder mixture; about 5 wt % of the powder mixture; about 7.5 wt % of the powder mixture; about 10 wt % of the powder mixture; about 12.5 wt % of the powder mixture; about 15 wt % of the powder mixture; about 16.7 wt % of the powder mixture; about 17.5 wt % of the powder mixture; about 20 wt % of the powder mixture; about 22.5 wt % of the powder mixture; or about 25 wt % of the powder mixture.

In some embodiments, the powder mixture in an inactive laboratory quench kit includes a hydrocarbon absorbent polymer such as, but not limited to, polypropylene hydrocarbon absorbent powder, polypropylene, polystyrene, polyurethane foam, polymethyl(meth)acrylate, and polyacrylic acid. In some embodiments, a powder mixture includes a hydrocarbon absorbent polymer in an amount of about 1 wt % to about 35 wt % of the powder mixture; about 5 wt % to about 30 wt % of the powder mixture; about 10 wt % to about 25 wt % of the powder mixture; about 15 wt % to about 20 wt % of the powder mixture; about 1 wt % of the powder mixture; about 2.5 wt % of the powder mixture; about 5 wt % of the powder mixture; about 7.5 wt % of the powder mixture; about 10 wt % of the powder mixture; about 12.5 wt % of the powder mixture; about 15 wt % of the powder mixture; about 16.7 wt % of the powder mixture; about 17.5 wt % of the powder mixture; about 19.2 wt % of the powder mixture; about 20 wt % of the powder mixture; about 22.5 wt % of the powder mixture; about 25 wt % of the powder mixture; about 27.5 wt % of the powder mixture; about 30 wt % of the powder mixture; about 32.5 wt % of the powder mixture; or about 35 wt % of the powder mixture.

The powder composition may be introduced to the inactive one-pot vessel using a funnel or any other suitable transfer device. After introduction of the powder mixture into the vessel, the methamphetamine laboratory reactants become sequestered and quenched by the fire retardant matrix, as illustrated in FIG. 5. The vessel may then be handled or transported without the risk of catching on fire.

### EXAMPLES

### Example 1

A powder mixture was prepared according to the following formulation:

10 grams PEO

20 grams crospovidone

20 grams Amberlite™

0.5 gram Blue #9 Powder

The powder mixture was introduced to an active methamphetamine one-pot synthesis vessel using a funnel. A visually distinct blue layer formed within a few minutes, indicating that the water had been successfully sponged and sequestered within the matrix of the sequestering/quenching agent.

### Example 2

A powder mixture was prepared according to the following formulation:

10 grams PEO

20 grams crospovidone

20 grams of sodium polyacrylate

0.5 gram Red #1 Powder

The powder mixture was introduced to an active methamphetamine one-pot synthesis vessel using a funnel. A visually distinct red layer formed within a few minutes, indicating that the water had been successfully sponged and sequestered within the matrix of the sequestering/quenching agent.

### Example 3

A powder mixture was prepared according to the following formulation:

200 grams Gypsum

10 grams PEO

50 grams polypropylene hydrocarbon absorbent powder

The powder composition was introduced to an inactive methamphetamine one-pot synthesis vessel using a funnel. The methamphetamine laboratory reactants became sequestered and quenched by the fire retardant matrix.

### Example 4

A powder mixture was prepared according to the following formulation:

200 grams Gypsum

50 grams Amberlite™

50 grams polypropylene hydrocarbon absorbent powder

The powder composition was introduced to an inactive methamphetamine one-pot synthesis vessel using a funnel. The methamphetamine laboratory reactants became sequestered and quenched by the fire retardant matrix.

The term “about,” as used herein, should generally be understood to refer to both the corresponding number and a range of numbers. Moreover, all numerical ranges herein should be understood to include each whole integer within the range, and other embodiments can have other dimensions. Accordingly, the specific embodiments described herein should be understood as examples and not limiting the scope thereof

While illustrative embodiments of the disclosure are disclosed herein, it will be appreciated that numerous modifications and other embodiments may be devised by those skilled in the art. For example, the features for the various embodiments can be used in other embodiments. Therefore, it will be understood that the appended claims are intended to cover all such modifications and embodiments that come within the spirit and scope of the present disclosure.

1. An active methamphetamine synthesis laboratory quenching powder mixture comprising:
a hygroscopic polymer;
a disintegrant;
an ion exchange resin; and
a water soluble dye.

2. The powder mixture of claim 1, wherein the hygroscopic polymer is present in an amount of about 17 wt % to about 23 wt % of the powder mixture.

3. The powder mixture of claim 1, wherein the hygroscopic polymer comprises polyethylene oxide.

4. The powder mixture of claim 1, wherein the disintegrant is present in an amount of about 35 wt % to about 45 wt % of the powder mixture.

5. The powder mixture of claim 1, wherein the disintegrant comprises crospovidone.

6. The powder mixture of claim 1, wherein the ion exchange resin is present in an amount of about 35 wt % to about 45 wt % of the powder mixture.

7. The powder mixture of claim 1, wherein the ion exchange resin comprises sodium polyacrylate.

8. The powder mixture of claim 1, wherein the water soluble dye is present in an amount of about 0.7 wt % to about 2 wt % of the powder mixture.

9. An inactive methamphetamine synthesis laboratory quenching powder mixture comprising:
gypsum;
a hygroscopic polymer; and
a hydrocarbon absorbent polymer.

10. The powder mixture of claim 9, where the gypsum is present in an amount of about 65 wt % to about 80 wt % of the powder mixture.

11. The powder mixture of claim 9, wherein the hygroscopic polymer is present in an amount of about 2 wt % to about 6 wt %.

12. The powder mixture of claim 9, wherein the hygroscopic polymer comprises polyethylene oxide.

13. The powder mixture of claim 9, wherein the hydrocarbon absorbent polymer is present in an amount of about 15 wt % to about 20 wt %.

14. The powder mixture of claim 9, wherein the hydrocarbon absorbent polymer comprises polypropylene hydrocarbon absorbent powder.

15. An inactive methamphetamine synthesis laboratory quenching powder mixture comprising:
gypsum;
an ion exchange resin; and
a hydrocarbon absorbent polymer.

16. The powder mixture of claim 15, where the gypsum is present in an amount of about 65 wt % to about 80 wt % of the powder mixture.

17. The powder mixture of claim 15, wherein the ion exchange resin is present in an amount of about 15 wt % to about 20 wt %.

18. The powder mixture of claim 15, wherein the ion exchange resin comprises Amberlite.

19. The powder mixture of claim 15, wherein the hydrocarbon absorbent polymer is present in an amount of about 15 wt % to about 20 wt %.

20. The powder mixture of claim 15, wherein the hydrocarbon absorbent polymer comprises polypropylene hydrocarbon absorbent powder.

21. A method of stabilizing an active methamphetamine synthesis vessel, comprising adding the powder mixture of claim 1 to a vessel containing solvent and lithium.

22. The method of claim 21, comprising sequestering the solvent from the lithium.

23. The method of claim 22, wherein the solvent is sequestered in a matrix.

24. A method of stabilizing an inactive methamphetamine synthesis vessel, comprising adding the powder mixture of claim 9 to a vessel containing lithium.

25. A method of stabilizing an inactive methamphetamine synthesis vessel, comprising adding the powder mixture of claim 15 to a vessel containing lithium.
